(19) United States
(12) Patent Application Publication
(10) Pub. No.: US 2005/0043017 A1
(43) Pub. Date: Feb. 24, 2005

(54) Methods and apparatus for provision of centralized calling information and features to wireless users

(75) Inventors: Daniel Esposito, Naperville, IL (US); Chung-Zin Liu, Naperville, IL (US); E-Ling Lou, Naperville, IL (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ (US)

(21) Appl. No.: 10/642,991

(22) Filed: Aug. 18, 2003

(51) Int. Cl. H04Q 7/20

(52) U.S. Cl. 455/414.1

(57) ABSTRACT

Systems and techniques for providing calling information and features to a wireless telephone are described. A server hosting directory information and commands used to implement calling features establishes a packet data connection to a wireless device. The wireless device uses the packet data connection to locate and retrieve desired calling information and commands. The calling information is used by the wireless device initiate a voice connection to a telephone identified by the calling information. The commands are executed by the wireless device in order to implement calling features provided by the system in which the wireless device is used.

### FIELD OF THE INVENTION

The present invention relates generally to improvements in wireless communication. More particularly, the invention relates to advantageous techniques and systems for centralized storage of calling information and features for access by wireless telephone users.

### BACKGROUND OF THE INVENTION

Centralized office exchange (Centrex) services have been widely available to wireline telephone users for many years. One convenient implementation of Centrex for wireline users has been Centrex internet protocol (Centrex IP) services. Centrex IP allows a user to gain access to centralized calling information, such as a telephone directory for an organization, through an internet protocol (IP) connection. Centrex IP further allows a user to receive information and issue commands through the same IP connection. For example, a user may be presented with an opportunity to search an organizational directory through the IP connection. The directory may be displayed on a user device having an IP connection to the directory, such as a workstation, personal computer or the like, and the user may employ the device, for example a workstation, to issue search commands through the IP connection in order to find a desired telephone number. The user may further employ the workstation to direct that the desired telephone number be called. This calling may be accomplished by selecting the desired directory entry. This selection initiates a telephone call through a conventional telephone switching system, to which the user has access in parallel with the IP connection to the Centrex IP system.

Centrex IP services are convenient to landline users, who frequently have a workstation available, with a stable IP connection allowing the workstation to be used for communication with the Centrex IP system or any other device accessible through the IP connection. However, provision of Centrex IP services to mobile users has been problematic using state of the art systems and devices. Prior art wireline Centrex IP systems frequently require parallel equipment for each user, for example, a wireline telephone used together with a workstation having an IP connection. Such parallel equipment is frequently undesirable for mobile users, who frequently wish to travel without carrying too many devices.

Mobile telephone services are continually becoming more widely used and more versatile. A relatively new feature of mobile telephones is their ability to establish and maintain IP connections independently of or in parallel with switched voice connections. A user whose telephone has this feature can gain access to information and services through an IP connection, and can also carry on a voice conversation through a mobile switched voice connection. In addition, a suitably equipped and programmed mobile telephone having IP connection capabilities can carry on voice communication over an IP connection, in parallel with data communication over an IP connection.

There exists, therefore, a need for systems for providing centralized information and features accessible over an IP connection maintained by a mobile telephone, and for telephones capable of using such information and features, as well as systems for maintaining simultaneous voice and data communications over an IP connection maintained by a mobile telephone, with centralized information and features provided to the telephone over the data connection.

### SUMMARY OF THE INVENTION

A wireless communication system according to one aspect of the invention includes a mobile switching center providing voice connection services to a plurality of wireless devices, such as wireless telephones. The mobile switching center can provide voice connections between the wireless telephones, and also provides a connection to a public switched telephone network, in order to allow connections between the wireless telephones and wireline telephones. Each wireless telephone is supported by a radio network controller. The system may suitably include a plurality of radio network controllers. Each radio network controller supports one or more base stations, each base station serving wireless telephones in its vicinity.

The system suitably includes a server providing directory services and calling features, accessible by establishing an IP connection between a telephone desiring such services and the server. The telephone communicates with the server in order to search for a desired telephone number, and also to download commands needed to implement desired calling features. Once a desired telephone number has been located in the directory and provided to the telephone, the telephone number may be selected, for example by selection using the wireless telephone display and keypad, in order to initiate a call. In order to initiate the call, the wireless telephone initiates a connection suitable for voice communication. This connection may be initiated through the mobile switching center. Alternatively, the system may also include a voice over IP server, allowing the wireless telephone to initiate a voice over IP connection. In such a case, the voice over IP server manages an IP data stream to and from the wireless telephone, performing necessary translation between IP data and voice signals, and manages the transmission of communication data between the wireless telephone and the called telephone, suitably by providing a connection to a wired or wireless switching network, depending on the nature of the telephone being called.

In addition to using directory information to place calls, a wireless telephone may receive commands from the directory and features server and use these commands to implement calling features, such as monitoring a telephone that is busy when called and alerting the user when the telephone being monitored is no longer busy. Such commands may be downloaded from the directory and features server upon initial connection, or alternatively a command may be downloaded when needed.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a wireless communication system according to an aspect of the present invention;

FIG. 2 illustrates a wireless communication system according to an alternative aspect of the present invention; and

FIG. 3 illustrates a process of wireless communication according to an aspect of the present invention.

### DETAILED DESCRIPTION

The present invention will be described more fully hereinafter with reference to the accompanying drawings, in which several presently preferred embodiments of the invention are shown. This invention may, however, be embodied in various forms and should not be construed as limited to the embodiments set forth herein. Rather, these embodiments are provided so that this disclosure will be thorough and complete, and will fully convey the scope of the invention to those skilled in the art.

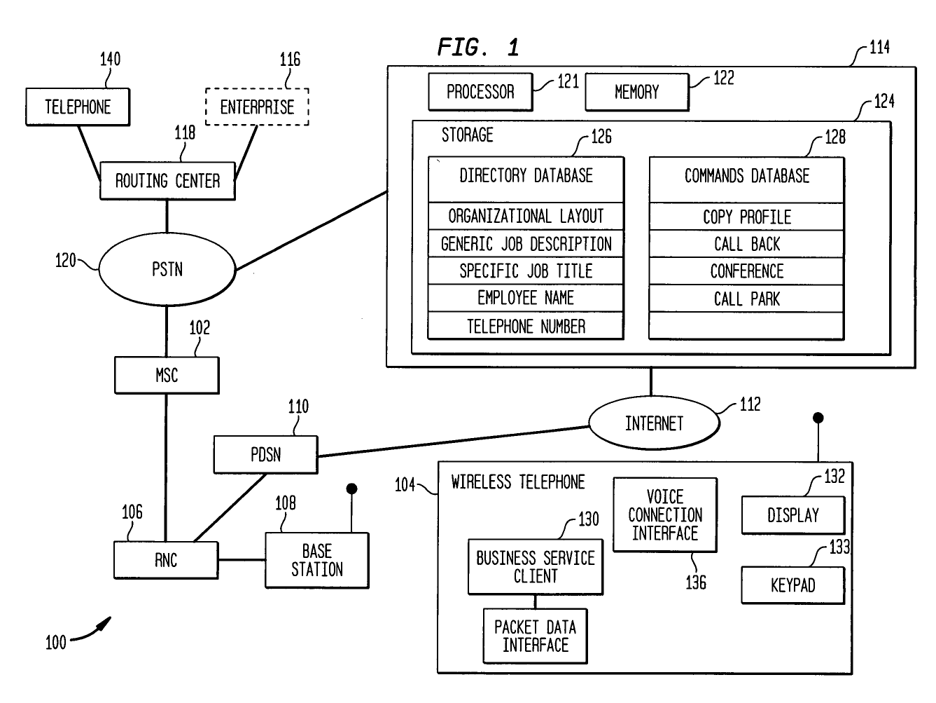

FIG. 1 illustrates a wireless communication system 100 according to one aspect of the invention. The system 100 includes a mobile switching center (MSC) 102 providing voice connection services to a plurality of wireless communication devices, such as wireless telephones, of which the telephone 104 is illustrated here. While a telephone 104 is illustrated here, it will be recognized that a system such as the system 100 may be employed using any of a wide variety of wireless devices having switched voice and packet data capabilities. Examples of such devices include but are not limited to personal digital assistants and suitably adapted laptop computers. It will also be recognized that the capabilities provided by a device such as the telephone 104 may be provided by a suitable combination of wireless devices, for example a device having switched voice capability and a separate device having packet data capability, with the devices being connected through a suitable interface. The MSC 102 can provide voice connections between a plurality of wireless devices such as the telephone 104. The MSC 102 communicates with each device such as the telephone 104 through a radio network controller (RNC), supporting a base station in the vicinity of the device. A single RNC 106 and base station 108 are illustrated here, but it will be recognized that the MSC 102 may be and typically will be connected to a number of base stations, with each RNC supporting a number of base stations, and each base station supporting a number of devices. Each device may move freely between base stations.

The RNC 106 provides the telephone 104 with a connection to a packet data serving node (PDSN) 110, which allows the telephone 104 access to an internet protocol (IP) network such as the Internet 112. The telephone 104 can gain access to any of a number of services and devices through the Internet 112.

The system 100 includes an enhanced business service application server 114, accessible to the telephone 104 through a packet data connection. The server 114 may suitably be maintained by or for an enterprise 116 maintaining centralized directory services and centrally controlled calling features, and includes various elements allowing a user of the telephone 104 to obtain desired information, such as directory information, and to issue desired commands, such as a command to dial a telephone number that has been looked up in the directory. Calls to telephones or similar devices within the enterprise 116 may suitably be routed through a routing center 118. The routing center 118 may suitably be a switching center, such as a private branch exchange (PBX) owned and maintained for the enterprise 116. Alternatively, the routing center 118 may be a pool of telephone lines maintained as part of a Centrex service provided by a telephone company.

The routing center 118 is accessible by the telephone 104 through a PSTN 120, through a voice connection to the PSTN 120 provided by the MSC 102. The routing center 118 suitably executes commands issued by the telephone 104 through the voice connection, such as a command to send a signal to the telephone 104 when a designated event occurs. For example, a called telephone may be busy, and the user of the telephone 104 may issue a command to the routing center 118 to send a signal when the called telephone is no longer busy.

The server 114 suitably includes a processor 121, memory 122 and long term storage 124. The server 114 hosts a directory database 126, suitably maintained in long term storage 124. The database 126 includes a plurality of records, there being at least one record for each telephone number associated with a telephone belonging to the enterprise. Each record in the database 126 suitably includes a telephone number, along with informational elements relevant for identifying and retrieving the telephone number. For example, a record suitably includes the telephone number, the name of the employee associated with the telephone number, the job title of the employee and a complete departmental listing of the employee, including a complete hierarchical structuring of the employee's position in the enterprise. With this information, it is possible for a caller who may not know the name or specific job function of an employee to nevertheless reach the correct employee by being led through a hierarchical listing or a series of functional descriptions.

In addition to the directory database 126, the server 114 hosts a commands database 128. The commands database 128 includes commands for the implementation of various features available to callers to the routing center 118. Commands may include, for example, a command to copy a user profile to the telephone 104, so that the telephone 104 may be shared among different users with each user being able to conveniently configure the telephone 104 to his or her preferences. Other commands include a “call back” command, that is, a command to alert the user when a called telephone that was busy when first called is no longer busy. Still other commands include a “conference” command, allowing the user to add additional parties to a call, and a “call park” command, allowing a user to place a call on hold in such a way that it can be retrieved from a different telephone operating in the same central system as the telephone 104. Different commands may be available to different classes of users. For example, an employee of the enterprise 116 may be allowed access to more features than may an outside caller, such as a customer.

The telephone 104 suitably includes an enhanced business service client module 130, to allow communication with the server 114. The business service client module 130 suitably communicates with the server 114 using a data packet connection, employing a packet data interface 131. The packet data interface 131 is used to facilitate data packet communications between the telephone 104 and a specified device, suitably by means of an IP address or URL provided to the packet data interface 131. In order to communicate with the server 114, the packet data interface 131 is provided with the address of the server 114 and establishes a data packet connection with the server. The business service client 130 then provides information to the interface 131 for transfer to the server 114 and receives information relayed from the server 114 by the interface 131.

The telephone 104 further includes a display 132 and a keypad 133, allowing the user to receive information and to issue commands through a packet data connection to the server 114, as well as to make voice calls and invoke conventional functions of the telephone 104.

When a user wishes to invoke calling features provided by the server 114, he or she invokes the business service client module 130. The business service client module 130 establishes a packet data connection with the server 114. The information provided to the client module 130 by the server 114 may suitably include information retrieved from the databases 126 and 128, as well as interface information which may be processed and formatted by the client module 130 and presented to the user through the display 132 in order to allow user selections. Presentation to the user may suitably be in the form of selection menus allowing the user to make selections from a list or to provide parameters to restrict the list as desired. The module 130 formats user information for display using the telephone display 132. Initial presentation of information to the user may suitably take the form of an introductory selection menu allowing the user to make various selections relating to searching a directory in order to call a desired party. As an example, the introductory menu may present a choice to allow a user to select from a top level directory, a choice to enter various parameters defining the directory information to be presented or a choice to conduct a directory search. Choices may include selection from a general level directory, such as a list of departments, or may include a directory search in which a user enters information which is used to search the directory 126. If the user chooses selection from a general level directory, a predetermined set of choices is delivered to the module 130, which then formats the choices and presents them using the display 132. The user may then make selections from the general level directory, and each of these selections may be associated with a more detailed directory, which may itself be associated with a still more detailed directory. For example, an initial directory may include general operations, accounting, sales, human resources, and legal. If “sales” is selected, a new directory may be presented, including catalog sales, retail sales, dealer sales and distributor sales. Each of these selections may be associated with a list of individual employees and telephone numbers.

Alternatively, the user may make a menu selection allowing the entry of parameters to be used to construct a directory search. Upon receiving this selection, the module 130 may prepare and present a form allowing user entries. The user may enter search terms which are then used to search the directory 126 in order to construct a list of directory entries for presentation to the user. The user may then select a directory entry which may then lead to a hierarchy of directories.

As a further alternative, the user may make a menu selection allowing a directory search. The module 130 presents a form, suitably by displaying the form using the display 132, allowing the user to enter search terms and searches the database 126 for records matching the search terms. A list of telephone numbers, with associated information such as the employee assigned to that telephone number or the job title of the employee assigned to the telephone number, is then presented to the user on the display 132, and the user may select an appropriate telephone number to be called.

When the user of the telephone 104 selects a number to be called, the module 130 invokes a voice connection interface 136 and provides the telephone number to the voice connection interface 136. The voice connection interface 136 dials the number in a conventional way, in order to establish a conventional switched voice connection.

The voice connection interface 136 is also operative to sense various conditions relating to the voice connection. Many routing centers such as the routing center 118 are able to detect when a telephone is busy and, in addition, when the telephone becomes available after being busy. In addition, a switchboard such as the routing center 118 may detect when a telephone is picked up. These features, as well as additional features, allow the provision of special services that may be implemented by a system such as the system 100.

Suitably, the commands database 128 includes a collection of downloadable commands that may be transmitted to the telephone 104 upon selection by a user or automatically if the correct conditions prevail. For example, suppose that the telephone 104 is used to call a telephone 140 served by the routing center 118. Further suppose that the telephone 140 is engaged, and the user receives a busy signal. The user then selects the option to be notified when the telephone 140 is no longer engaged. This option may suitably be included in a set of commands downloaded from the server 114 when the telephone 104 first establishes a packet data connection. Alternatively, the set of commands may be downloaded upon a request from the user. As a further alternative, a list of commands may be stored permanently in the telephone 104, with a desired command being downloaded to the telephone 104 upon selection by the user. As a still further alternative, a stored command may be invoked, or a command may be downloaded and either presented to the user as an option or else automatically invoked, when the circumstances call for it. Downloading commands to the telephone 104 from the server 114 allows increased versatility for the system 100, because a telephone such as the telephone 104 need not be preprogrammed with the commands needed to access special features used to communicate with a particular organization. Instead, any suitably equipped telephone can download the required commands needed to take advantage of the special features offered by a system with which it is to be used.

Suppose that the user has called the telephone 140 and the telephone 140 is busy. The user has then selected the “call back” feature in order to be notified when the telephone 140 is no longer busy. The routing center 118 detects whether the telephone 140, as well as every other telephone served by the routing center 118, is idle or busy. The server 114 periodically interrogates the routing center 118 in order to determine the status of each telephone for which a “call back” command has been issued by a telephone served by the server 114. When the telephone 140 becomes idle, the interrogation of the routing center alerts the server 114 that the telephone 140 is idle. The server 114 then issues an alert signal to the telephone 104. The signal is received by the packet data interface 131, which passes it to the business service client module 130. The business service client module 130 then alerts the user.

In addition, if the telephone 104 is suitably programmed, the business service client module 130 may automatically direct the voice connection interface 136 to dial the telephone 104. Other features may be implemented in a similar way, with the telephone 104 receiving status detected by the server 114 and executing appropriate commands that are either downloaded as needed from the server 114 or stored in the telephone 104 after an initial download from the server 114.

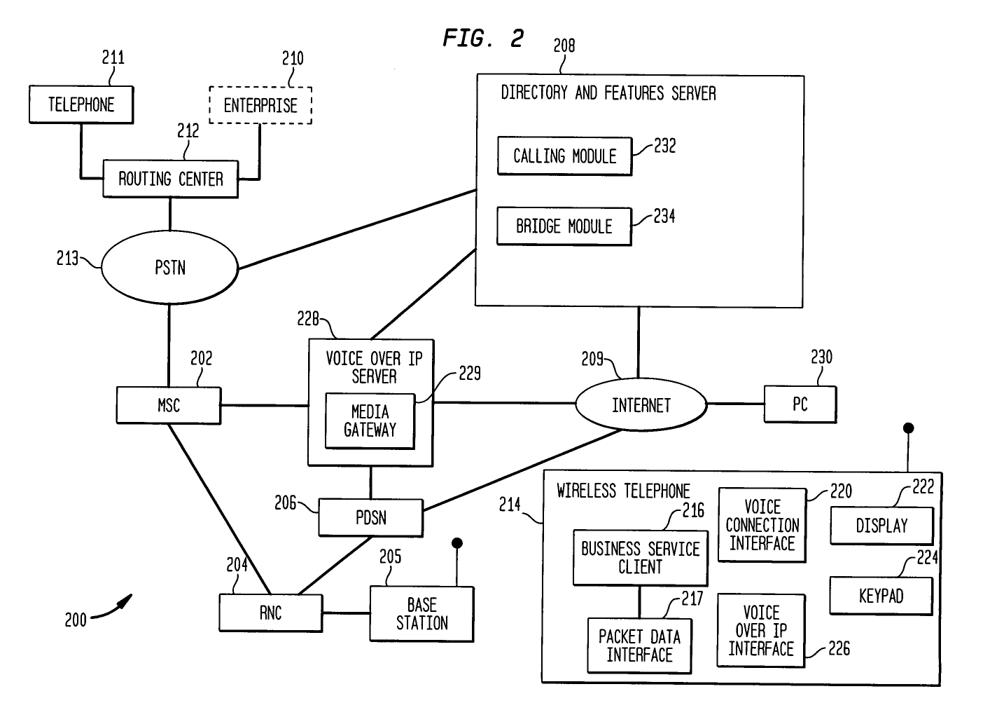

FIG. 2 illustrates a system 200 employing an alternative embodiment of the present invention. The system 200 includes an MSC 202, an RNC 204, a base station 205, a PDSN 206 and an enhanced business server 208, accessible through an IP connection such as the Internet 209. The system 200 allows communication with an enterprise 210, maintaining a network of telephones, such as a telephone 211 accessible through a routing center 212 that is in turn accessible through a PSTN 213. These elements are similar to corresponding elements of the system 100 and allow the system 200 to perform the same functions as the system 100. These elements will not be discussed in detail except insofar as they differ from corresponding elements of the system 100.

In addition to the elements mentioned above, the system 200 includes a wireless telephone 214 including a business service client module 216, similar to the module 130 of FIG. 1, a packet data interface 217, similar to the packet data interface 131 of FIG. 1, a display 220 and a keypad 222. In addition, the telephone 214 includes a voice connection interface 224 similar to the voice connection interface 136 of FIG. 1, and a voice over IP module 226. The voice over IP module 226 allows the telephone 214 to perform voice communications using packet data transmission. While a telephone 214 is illustrated here, it will be recognized that a system such as the system 200 may be employed using any of a wide variety of wireless devices having packet data capabilities and voice over IP capability. Examples of such devices include but are not limited to personal digital assistants and suitably adapted laptop computers. Such devices may also, if desired be designed so as to support switched voice capability. If switched voice capability is provided, it will be recognized that the capabilities provided by a device such as the telephone 214 may be provided by a suitable combination of wireless devices, for example a device having switched voice capability and a separate device having packet data capability, with the devices being connected through a suitable interface. For example, a personal digital assistant providing packet data and voice over IP capabilities may normally be used alone, but may include an interface to accept a device providing switched voice capability. When it is anticipated that the personal digital assistant may be used in a switched voice communication, a device providing switched voice capability may be connected to the personal digital assistant through the interface.

In order to support voice communication using packet data transmission, the system 200 also includes a voice over IP server 228. The voice over IP server 228 provides session initiation protocol (SIP) services allowing interactive voice communication by a user employing the telephone 214. SIP provides for the initiation of an interactive user session including multimedia elements including voice, video, chat, gaming and virtual reality. The server 228 allows communication using a packet data stream provided by the module 226 belonging to the telephone 214, and translates the packet data stream into signals that can be transmitted by the PSTN 213. The voice over IP server 228 provides a connection to the PSTN 213, using a media gateway 229. The media gateway 229 supports a connection to the MSC 202 and to the PDSN 206, and performs any translation necessary to support communication between the PSTN 213 and the PDSN 206.

The system 200 operates in a manner similar to that of the system 100 described above, except that the telephone 214 has the option of establishing a voice over IP connection to the telephone 211 and similar telephones. When a voice over IP connection is to be made, the voice over IP module 226 establishes a packet data connection to the voice over IP server 228, and sends to the server 228 a stream of data packets embodying voice data. The voice over IP server 228 establishes a connection to the telephone 211 through the PSTN 213, and translates the stream of data packets to a form usable by the PSTN 213, typically analog telephone signals. Similarly, the server 228 translates responses received over the PSTN 213 into a stream of data packets, which is transmitted to the telephone 214 and interpreted by the voice over IP module 226. The business service client module 216 and the client interface 218 operate in a manner similar to that described above in connection with the system 100 of FIG. 1, but when a need arises to carry out voice communications, the client module 216 may invoke the voice over IP module 226 or the voice connection interface 220 to carry out the voice communications.

If desired, a system such as the system 200 can be designed in additional alternative configurations. The telephone 214 may gain access to the server 208 through a workstation such as a computer 230, which in turn provides access to the server 208. The telephone 214 establishes a connection to the computer 230 through a wireless packet radio interface, provided by the operation of the base station 205, RNC 204 and PDSN 206. Information received from the server 208 by the computer 230 is suitably displayed by the computer 230, and also relayed to the telephone 214. When a user has access to the computer 230, the routing of information through the computer 230, and the display of information by the computer 230, provides more convenient viewing of information through a larger display typically provided by a computer such as the computer 230. The operation of the system 200 is similar to that described above, with the computer 230 simply providing an alternative means of access to the server 208. The system 100 of FIG. 1 can be configured in a similar way.

An additional alternative mode of operation requires that the server 208 have connections to one or both of the PSTN 213 and the voice over IP server 228. The connection to the PSTN 213 can be accomplished by providing the server 208 with an ordinary telephone connection. In this mode of operation, a call is established by the server 208 when a selection is made to call a number. The server 208 employs a calling module 232 in order to establish a voice connection with the telephone to be called, either through the PSTN 213 for a switched voice connection or the voice over IP server 228 for a voice over IP connection, as well as the telephone 214. The server 208 then employs a bridge module 234 to bridge the two calls together. It will be recognized that the system 100 of FIG. 1 can be similarly adapted.

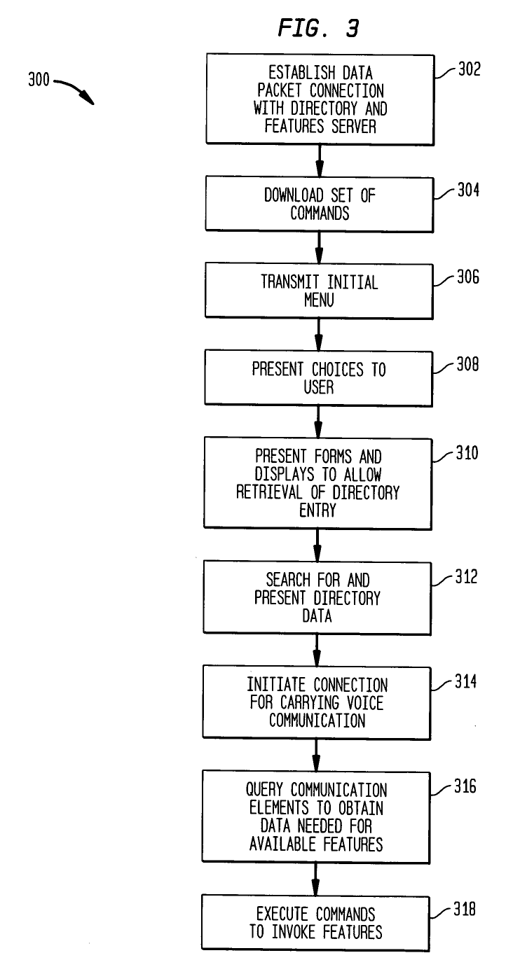

FIG. 3 illustrates a process of wireless communication 300 according to an aspect of the present invention. At step 302, a packet data connection is established with a directory and features server, in order to retrieve data and invoke features used for communication with an enterprise by or for which the server is maintained. The connection may suitably be established using a wireless device, such as a wireless telephone, having packet data capability. At optional step 304, a set of commands may be downloaded to the telephone, in order to provide user access to features available for communication with the enterprise. At step 306, an initial menu is transmitted to the telephone from the server and formatted and presented for a user. For example, the menu may displayed using a display, such as the display 132 of FIG. 1 or the display 222 of FIG. 2. The initial menu may suitably include a top level directory and choices for navigating through the directory, for example a selection to navigate through a hierarchical directory structure, a selection to provide parameters for narrowing the directory choices or a selection to conduct a directory search. Upon a user selection, the process proceeds to step 308 and appropriate choices are presented to the user. The choices may include presentation of a hierarchical directory structure, allowing the user to navigate through the structure to a single entry, presentation of a directory format allowing the user to provide parameters to restrict and define the directory structure in order to provide navigation through a more restricted set of choices, or a directory format allowing user entry of search terms in order to allow a direct search for a single entry. At step 310, upon receiving a user choice, the selected directory format is chosen and appropriate forms and displays are presented to the user to allow the user to find an appropriate directory entry. Upon receiving choices and commands from the user, the process proceeds to step 312 and directory data is searched and transmitted to the telephone for presentation to the user in accordance with user selections until a single directory entry has been found and presented. Upon a user selection of this directory entry, the process proceeds to step 314 and a connection suitable for carrying voice communications is initiated with a telephone associated with the directory entry. This connection may suitably be made using a conventional wireless switched connection or a voice over IP connection using a voice over IP server.

At suitable times during the process 300, the process may proceed to optional step 316, in order to query one or more elements with which communication is being carried out, in order to provide information needed to invoke available features. For example, information may be received from a telephone to which a call is being made in order to determine whether the telephone is already engaged, or a telephone that has been determined to be engaged may provide information indicating that it is no longer engaged. At step 318, commands may be executed in order to invoke features selected by the user. These commands may already be present in the wireless telephone as a result of having been previously downloaded, or may be retrieved from the directory and feature server as needed. Execution of the commands may occur upon direct user selection, or upon detection of a specified condition.

While the present invention has been disclosed in the context of various aspects of presently preferred embodiments, it will be recognized that the invention may be suitably applied to other environments consistent with the claims which follow.

1. A wireless communication system for supporting communication by a wireless device, comprising:
a packet data interface for supporting packet data communication by the wireless device;
a voice interface for supporting voice communication by the wireless device; and
a data server operative to provide data to the wireless device through a packet data connection in order to furnish data requested by the wireless device.

2. The system of claim 1, wherein the data server is a directory server operative to store a calling directory and to search the calling directory and provide desired calling information to the wireless device upon request.

3. The system of claim 2, wherein the data server is further operative to store a command set for the implementation of calling features available to the wireless device and to transfer desired commands to the wireless device when required.

4. The system of claim 3, wherein the voice interface includes a mobile switching center to support switched voice communication by the wireless device.

5. The system of claim 4, wherein the voice interface further includes a voice over internet protocol interface to support voice communication by the wireless device over a packet data connection.

6. The system of claim 5, wherein the data server is further operative to initiate a first call to a telephone number identified in the calling information provided to the wireless device, to initiate a second call to the wireless device, and to bridge together the first and second calls to establish a connection between the wireless device and the identified telephone number.

7. A wireless device for communication using directory information and calling features through a packet data connection with a data server, comprising:
a voice connection interface for establishing and maintaining a voice connection for voice communication through a switched voice network; and
a business service client module for retrieving calling information from the data server and for processing and presenting calling information received from the data server, the business service client module being operative to direct the initiation of voice communication with a desired telephone upon identification and retrieval of the desired telephone number from the data server.

8. The wireless device of claim 7, wherein the business service client module is further operative to retrieve commands from the data server and to implement calling features using the commands.

9. The wireless device of claim 8, further comprising a voice over internet protocol interface for establishing and maintaining a packet data connection in order to carry on voice communication through the packet data connection.

10. A method of wireless communication, comprising the steps of:
establishing a packet data connection between a wireless device and a directory and features server;
selecting desired calling information from the server and delivering the calling information to the wireless device; and
initiating and maintaining a call from the wireless device to a telephone identified by the calling information delivered from the server.

11. The method of claim 10, wherein the step of selecting the desired calling information further includes presenting a series of selection interfaces to the wireless device and conducting a search in the directory and features server based on user responses to the selection interfaces.

12. The method of claim 11, wherein the step of establishing the packet data connection is followed by a step of delivering a set of commands to the wireless device to allow access to calling features implemented by the commands.
